(19) United States
(12) Patent Application Publication
(10) Pub. No.: US 2009/0032075 A1
(43) Pub. Date: Feb. 5, 2009

(54) METHODS AND APPARATUS FOR LIQUID CHEMICAL DELIVERY

(75) Inventors: Richard Kok Hwee Lee, Singapore (SG); Alok Jain, Singapore (SG); Whee Yong Koh, Singapore (SG); James Chin Hock Tan, Singapore (SG); Hooman Bolandi, San Jose, CA (US); Simon Yavelberg, Cupertino, CA (US)

Correspondence Address: DUGAN & DUGAN, PC, 245 Saw Mill River Road, Suite 309, Hawthorne, NY, 10532, US

(73) Assignee: Applied Materials, Inc.

(21) Appl. No.: 12/249,921

(22) Filed: Oct. 11, 2008

Related U.S. Application Data
(62) Division of application No. 10/843,758, filed on May 11, 2004.

(51) Int. Cl. B08B 13/00; G05D 11/02

(52) U.S. Cl. 134/184; 137/602; 137/896; 137/861

(57) ABSTRACT

In a first aspect, an apparatus for chemical delivery to a scrubber is provided. The apparatus comprises: a liquid delivery module comprising: a first input adapted to receive a first input flow of a dilutant; a second input adapted to receive a second input flow of a chemistry; one or more flow couplers coupled to the first input and the second input, and adapted to combine the first input flow and the second input flow into a combined flow; a mixing element coupled to the one or more flow couplers, and adapted to mix the combined flow such that a homogeneity of the combined flow is increased; a flow splitter coupled to the mixing element and adapted to generate at least a first output flow and a second output flow from the combined flow; a first output coupled to the flow splitter and adapted to direct the first output flow toward a first scrubber dispensing element; and a second output coupled to the flow splitter and adapted to direct the second output flow toward a second scrubber dispensing element. Numerous other aspects are provided.

This application is a division of, and claims priority, to U.S. patent application Ser. No. 10/843,758, filed May 11, 2004, and titled, “METHODS AND APPARATUS FOR LIQUID CHEMICAL DELIVERY” (Attorney Docket No. 8519), which is hereby incorporated by reference herein in its entirety for all purposes.

### FIELD OF THE INVENTION

The present invention relates to the manufacture of semiconductor devices. In particular, the present invention relates to methods and apparatus for cleaning semiconductor substrates.

### BACKGROUND OF THE INVENTION

During semiconductor device fabrication, semiconductor substrates may be subjected to one or more cleaning steps. In some cases, such cleaning steps may use a substrate cleaning apparatus such as a scrubber. For example, a scrubber box having one or more brushes may be used, wherein the semiconductor substrate to be cleaned may be introduced into the scrubber box, and the scrubber brushes may be closed against the substrate. The scrubber brushes may then be rotated relative to the substrate, subjecting the substrate to one or more types of mechanical and/or chemical cleaning actions (e.g., depending on the surface geometry of the rotary scrubber brushes used, and/or the number, size and distribution of pores of the brushes, and/or the nature of the cleaning fluid used).

Defect reduction may be an important consideration in the development and/or implementation of a semiconductor device manufacturing process. For example, since the emergence of copper metallization as a leading interconnect in semiconductor device fabrication, the tendency of copper oxide (CuxO) or so-called ‘aphids’ to form on substrate surfaces during substrate polishing has been identified as an important cause/source of defects in semiconductor devices. As such, at least one goal of cleaning steps after substrate polishing, such as post chemical mechanical polishing (CMP) substrate scrubbing, may be to achieve effective removal of CuxO from substrate surfaces.

Accordingly, effective methods and/or apparatus for reliably removing defects, particularly copper oxides from substrate surfaces are desirable.

### SUMMARY OF THE INVENTION

In a first aspect of the invention, a method of chemical delivery is provided. The method includes the steps of (1) receiving a first input flow of a dilutant; (2) receiving a second input flow of a chemistry; (3) combining the first and the second input flows into a combined flow; (4) employing a mixer to mix the combined flow such that a homogeneity of the combined flow is increased; (5) dividing the combined flow into at least a first output flow and second output flow; (6) directing the first output flow toward a first scrubber dispensing element; and (7) directing the second output flow toward a second scrubber dispensing element.

In second aspect of the invention, an apparatus is provided for chemical delivery to a scrubber. The apparatus includes a liquid delivery module having (1) a first input adapted to receive a first input flow of a dilutant; (2) a second input adapted to receive a second input flow of a chemistry; and (3) one or more flow couplers coupled to the first input and the second input, and adapted to combine the first input flow and the second input flow into a combined flow. A mixing element is coupled to the one or more flow couplers, and adapted to mix the combined flow such that a homogeneity of the combined flow is increased. The liquid delivery module also includes (1) a flow splitter coupled to the mixing element and adapted to generate at least a first output flow and a second output flow from the combined flow; (2) a first output coupled to the flow splitter and adapted to direct the first output flow toward a first scrubber dispensing element; and (3) a second output coupled to the flow splitter and adapted to direct the second output flow toward a second scrubber dispensing element. Numerous other aspects are provided.

Other features and aspects of the present invention will become more fully apparent from the following detailed description, the appended claims and the accompanying drawings.

### BRIEF DESCRIPTION OF THE FIGURES

FIG. 1 is a schematic illustration of a known liquid delivery module.

FIG. 2 is a schematically illustrated layout of a liquid delivery module in accordance with the present invention.

FIG. 3 is a schematically illustrated layout of another liquid delivery module in accordance with the present invention including an additional liquid chemistry input.

FIG. 4 is a schematically illustrated layout of another liquid delivery module in accordance with the present invention including an additional dilute liquid chemistry output.

### DETAILED DESCRIPTION

Liquid cleaning chemistries that act as effective agents for removal of CuxO during post copper CMP cleaning are known. For example, the liquid cleaning chemistry ElectraClean (EC), a combination of ammonium hydroxide and citric acid developed by Applied Materials, Inc., is one such effective chemical agent. However, the present inventors have observed that some liquid cleaning chemistries, such as EC, may cause one or more types of semiconductor device defects if the dilution factor of the liquid cleaning chemistry applied to the surface of the substrate being cleaned falls outside a desirable and/or predefined range. For instance, at an EC dilution factor of higher than 200:1, aphide formation may be seen to increase. At an EC dilution factor of lower than 150:1, intermittent corrosion of deposited copper conductor lines may be observed to occur. As such, maintaining a dilution factor of EC within a process window of about 150-200:1 may be an important goal relating to defect reduction.

For convenience, the present invention will be described primarily with regard to the use of EC (and dilution thereof). It will be understood that the invention also may be employed with other cleaning fluids (e.g., Waco CX-100, Ashland CP70, ESC 794 or the like). Also for convenience, the present invention will be described with regard to the use of water as a liquid dilutant for EC. It will be understood that the invention also may be employed with other dilutants (e.g., Benzotriazole (BTA) alcohol (C₆H₅N₃) or the like).

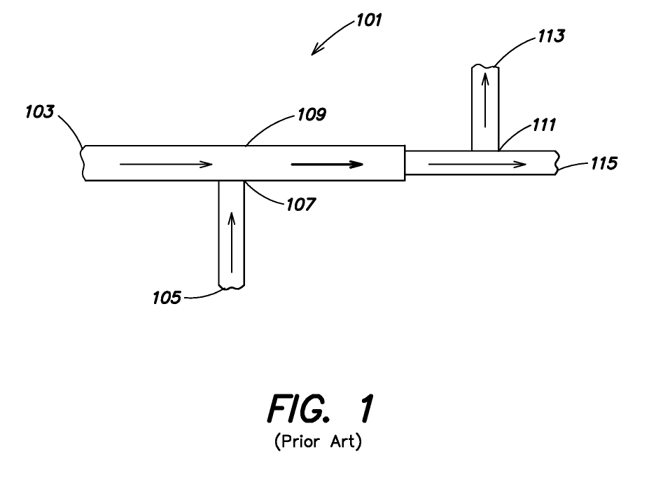

FIG. 1 is a schematic illustration of a known liquid delivery module 101 adapted to provide a dilute flow of liquid chemistry for delivery to the major surfaces of a substrate (not shown). The liquid delivery module 101 of FIG. 1 includes a first input 103 for water, e.g., DI water, and a second input 105 for EC liquid chemistry. The first input 103 and the second input 105 connect at a first joint 107, such that a confluence of DI water and EC liquid chemistry is formed. A common line 109 is adapted to receive the combined flow of DI water and EC liquid chemistry (which may also be referred to as dilute EC liquid chemistry). The common line 109 is also adapted to provide a downstream flow path for the dilute EC liquid chemistry. The common line 109 terminates at a second joint 111 or other flow splitter, which is adapted to divide the flow of dilute EC liquid chemistry into two separate output flows. A first output 113 of the second joint 111 provides a first output flow of dilute EC liquid chemistry, which may be directed toward a first liquid dispensing element (e.g., a spray bar, a scrubber brush, a nozzle, a jet, etc., of a scrubber box not shown in FIG. 1) located adjacent the substrate being cleaned. A second output 115 of the second joint 111 provides a second output flow of dilute EC liquid chemistry, which may be directed toward a second liquid dispensing element (not shown in FIG. 1), also located adjacent the substrate being cleaned (e.g., located adjacent an opposite side of the substrate being cleaned).

The use of the liquid delivery module 101 of FIG. 1 can result in a wide variation in the dilution factor of EC liquid chemistry delivered to the surface of a substrate being cleaned. For example, with respect to the liquid delivery module 101, the present inventors have observed a wide variation in the EC dilution factor as measured at the first liquid dispensing element (not shown) fed by the first output 113 relative to the EC dilution factor as measured at the second liquid dispensing element (not shown) fed by the second output 115. Also with respect to the liquid delivery module 101, the present inventors have observed a wide variation in the EC dilution factor as measured at the first liquid dispensing element (not shown) or the second liquid dispensing element (not shown) relative to a predetermined and/or desired dilution factor (e.g., a dilution factor within the 150-200:1 process window described above) corresponding to the respective (e.g., proportional to the) flow rates at the first and second inputs 103, 105 of the liquid delivery module 101. In at least some instances, the variation in EC dilution factor at one or more of the first or second liquid dispensing elements (not shown) may amount to a disparity of about +/−40%, or even higher, thus increasing the possibility that EC will be applied to substrate surfaces at a dilution factor that may cause semiconductor device defects.

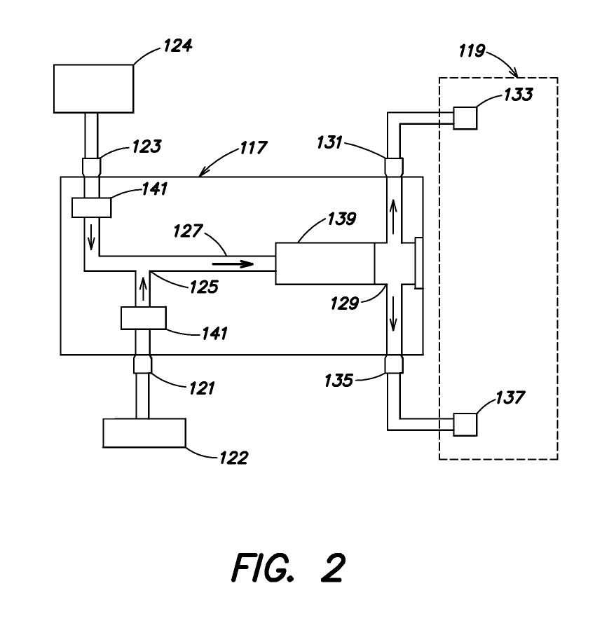

FIG. 2 shows a schematically illustrated layout of an inventive liquid delivery module 117 adapted to provide a dilute flow of liquid chemistry for delivery to the major surfaces of a substrate (not shown) disposed within a scrubber 119 (shown in phantom). The liquid delivery module 117 of FIG. 2 may be mounted adjacent one or more polishing tools, within a polishing tool and/or on an individual scrubber module to perform local dilution of liquid chemistry (such as the cleaning chemistry EC), and is adapted to reduce and/or eliminate at least one, any, and/or all of the above-described wide variations in output chemistry dilution factor that may characterize the liquid delivery module 101 of FIG. 1.

In some embodiments, for example, the liquid delivery module 117 of FIG. 2 is adapted to reduce a difference in chemistry (e.g., EC) dilution factor between two dilute liquid chemistry outputs branching from an upstream combined flow to about 3% or less (e.g., between at least a first and a second output flow). The liquid delivery module 117 of FIG. 2 also may be adapted to reduce to about 3% or less a difference between (1) the chemistry (e.g., EC) dilution factor of one of a plurality of liquid chemistry outputs branching from an upstream combined flow; and (2) the chemistry dilution factor of the upstream combined flow (e.g., a predetermined and/or desired input chemistry dilution factor derived from respective input flow rate proportions). At least by being adapted to reduce and/or eliminate wide input-output variations, and/or wide output-output variations, in chemistry dilution factor, the liquid delivery module 117 is adapted to reliably reduce and/or eliminate the occurrence of semiconductor device defects arising out of poor control over post CMP cleaning chemistry dilution.

The liquid delivery module 117 of FIG. 2 may include a first input 121 adapted to couple to a dilutant source 122 such as a source of water (e.g., deionized (DI) water), and receive an input flow (e.g., a first input flow) of the dilutant. The liquid delivery module also includes at least a second input 123 adapted to couple to and receive an input flow (e.g., a second input flow) of chemistry from a respective source 124 of the chemistry (e.g., EC liquid chemistry). The first input 121 and the second input 123 connect at a first joint 125 (e.g., a flow coupler) adapted to combine the first and second input flows into a combined flow, such that a confluence of DI water and liquid chemistry is formed (e.g., a dilute EC liquid chemistry). A common line 127 is adapted to receive and provide a downstream flow path for the dilute liquid chemistry.

The common line 127 terminates at a second joint 129, which is adapted to divide the flow of dilute liquid chemistry into two separate output flows. A first output 131 coupled the second joint 129 provides a first flow of dilute liquid chemistry, which may be directed toward a first liquid dispensing element 133 within the scrubber 119. The first liquid dispensing element 133 of the scrubber 119 may be located adjacent a substrate (not shown) to be cleaned, and may be one of any suitable type of liquid dispensing element, such as a spray bar, a scrubber brush, a nozzle, etc. A second output 135 coupled to the second joint 129 provides a second flow of dilute liquid chemistry, which may be directed toward a second liquid dispensing element 137 within the scrubber 119. The second liquid dispensing element 137 of the scrubber 119 may be located adjacent the same side of the substrate to be cleaned, or adjacent an opposite side of the substrate to be cleaned, relative to the first liquid dispensing element 133. The second output 135 also may supply the second flow of dilute liquid chemistry to a different substrate.

The liquid delivery module 117 of FIG. 2 is different from the liquid delivery module 101 of FIG. 1 in at least one or more ways that may result in the liquid delivery module 117 being adapted to reduce and/or eliminate wide variation in the chemistry dilution factor between the liquid dispensing elements 133, 137, and/or between the chemistry dilution factor of one or more of the liquid dispensing elements 133, 137 and a predetermined chemistry dilution factor based on input flow rate proportions (particularly with regard to EC dilution). For example, the liquid delivery module 117 includes a mixing element 139. The mixing element 139 may be adapted to mix and/or homogenize the flow of dilute liquid chemistry prior to the branching that occurs at the second joint 129. In one embodiment, the mixing element 139 may provide an accuracy of about +/−3% or better for a chemical dilution factor of about 200:1. The mixing element 139 may be disposed within, and/or may comprise an integrated part of (e.g., an in-line integrated extension of) the common line 127, and as such may be configured to mix the flow of dilute liquid chemistry passing through the common line 127. Other dispositions are possible. The mixing element 139 may be one of any suitable type of mixing element, such as a static mixer, a dynamic mixer, an inductive mixer, a diffuser, a blender, etc.

Other differences between the liquid delivery module 117 of FIG. 2 and the liquid delivery module 101 of FIG. 1 also may provide for enhanced mixing and/or homogeneity at the second joint 129. For instance, the liquid delivery module 117 may include a turn in the flow of DI water defined by the first joint 125 between the first input 121 and the common line 127 (e.g., a ninety degree turn as shown in FIG. 2, as opposed to the lack of any such turn as in the liquid delivery module 101 FIG. 1). Such a turn in the flow path of the relatively high-volume DI water input may, for example, tend to enhance blending (e.g., of the first and second input flows) via the formation of eddies and/or other types of flow disturbances or turbulence arising from the flow redirection. In one embodiment, the liquid delivery module 117 is adapted to receive a 1500-2000 milliliters per minute flow of the dilutant (e.g., DI water) and a 5-10 milliliters per minute flow of chemistry to be diluted (e.g., EC liquid chemistry). The liquid delivery module 117 may be adapted to receive different volumes of dilutant and/or chemistry.

The liquid delivery module 117 may further include one or more check valves 141 between at least one of the inputs 121, 123 and the first joint 125. The check valves 141 may also contribute to good blending and/or mixing of the DI water and liquid chemistry. For example, the check valves 141 may induce rotation in at least one of the respective input flows, which may be beneficial for blending purposes upon confluence of the input flows. In at least one embodiment of the invention, the various components of the liquid delivery module 117 (e.g., the first input 121, the second input 123, the first joint 125, the common line 127, the second joint 129, the first output 131, the second output 135, the mixing element 139, the check valves 141, etc.) may comprise a single unit (e.g., may be disposed in or comprise part of a single manifold as shown in FIG. 2). A compact, modular liquid delivery unit thereby may be provided.

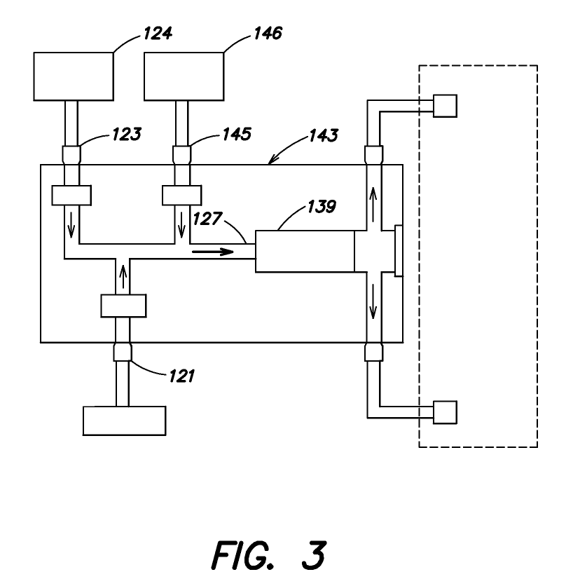

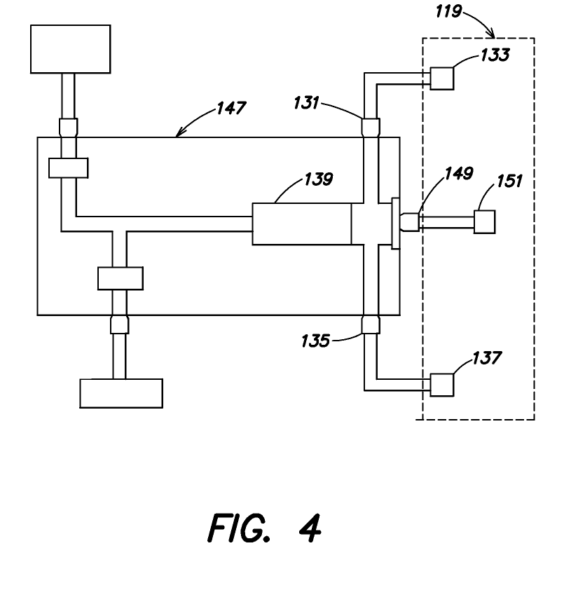

FIGS. 3 and 4 illustrate other embodiments of liquid delivery modules in accordance with the present invention. In particular, FIG. 3 illustrates a liquid delivery module 143 similar to the liquid delivery module 117 of FIG. 2, except that the liquid delivery module 143 includes a third input 145 adapted to couple to a source 146 of an additional liquid chemistry and receive an input flow (e.g., a third input flow) of the additional liquid chemistry (e.g., a second chemistry). The additional liquid chemistry flowing from the source 146 may also flow into and through the common line 127, and into and through the mixing element 139. In some embodiments, the third input 145 may be configured to introduce, from the source 146, a cleaning chemistry other than the chemistry (e.g., EC) introduced from the source 124. The third input 145 may be configured to introduce a surfactant, for example, from the source 146. Other types of liquid cleaning chemistry may similarly be introduced, either additionally, or in the alternative.

As with the liquid chemistry from the source 124, the dilution factor of the additional liquid chemistry introduced from the source 146 may be high (e.g., the combined flow proceeding through the common line 127 and/or the mixing element 139 may be highly dilute with respect to the additional liquid chemistry). The liquid delivery module 143 may be adapted to reduce and/or eliminate wide variation in the output dilution factor of the additional liquid chemistry in a manner similar to that in which it reduces and/or eliminates wide variation in the output dilution factor of the chemistry from the chemistry source 124. For example, the liquid delivery module 143 may be adapted to reduce dilution factor variation in the additional liquid chemistry to about 3% or less between different output flows, and/or to about 3% or less between one or more of the output flows and a predetermined dilution factor as reflected by the input flow proportions.

FIG. 4 illustrates a liquid delivery module 147 similar to the liquid delivery module 117 of FIG. 2, except that the liquid delivery module 147 includes a third output 149 (e.g., in addition to the first and second outputs 131, 135) for the delivery of another flow (e.g., a third output flow) of dilute chemistry (e.g., EC liquid chemistry) from the mixing element 139 to the surface of a substrate to be cleaned within the scrubber 119. For example, the additional output 149 may be configured to deliver or direct a flow of dilute chemistry (e.g., within a similar narrow range of variation as for the other outputs) to a third liquid dispensing element 151 disposed within the scrubber 119 adjacent the same substrate or substrates to which one of the first and second liquid dispensing elements 133, 137 are also adjacent, and/or adjacent one or more different substrates. As with the liquid delivery module 117 of FIG. 2, the various components of the liquid delivery modules 143, 147 may comprise a single unit (e.g., may be disposed in or comprise a single manifold as shown in FIGS. 3 and 4). The liquid delivery modules 143, 147 may be mounted adjacent and/or within a polishing tool and/or scrubber.

The foregoing description discloses only exemplary embodiments of the invention. Modifications of the above disclosed apparatus and methods which fall within the scope of the invention will be readily apparent to those of ordinary skill in the art. For example, more than two liquid chemical inputs may be employed, each for the introduction of different liquid chemistries, and a similar reduction and/or elimination of wide dilution factor variation relating to each liquid chemistry input may be accomplished in accordance with the present invention. Also, more than three dilute liquid chemistry outputs may be employed (e.g., for directing flows of dilute liquid chemistry to respective dispensing elements), and a similar reduction and/or elimination of wide dilution factor variation relating to each dilute liquid chemistry output may be accomplished in accordance with the present invention. Since the liquid delivery module of the present invention is adapted to be mounted adjacent the substrate scrubber it serves, and is adapted to provide local dilution of liquid chemistries with liquid dilutant, one or more of the source of liquid dilutant (e.g., DI water), and/or the sources of liquid chemistries may be located remotely with respect to the liquid delivery module. In addition, liquid dispensing elements that are coupled to dilute liquid chemistry outputs that branch from the same combined flow in accordance with the present invention, and that are adjacent the same substrate, need not be adjacent the same surface of the substrate. Such liquid dispensing elements may be adjacent different (e.g., opposite) sides of the same substrate. Also, liquid dispensing elements may be disposed in different substrate scrubbers.

Liquid chemistry dilution factors outside the range of 150:1 to 200:1 may be employed. Maintaining other dilution factors according to different preferred input proportions and/or for different liquid chemistries, such as a surfactants, is similarly achievable using the inventive methods and apparatus of the present application.

Joints disposed at the confluence of input flows, and/or disposed upstream of output flows in accordance with the present invention may be any suitable flow couplers. Also, where more than two inputs are combined in accordance with the present invention, or more than two outputs are provided in accordance with the present invention, one joint or flow coupler need not form all the needed connections. Multiple joints or flow couplers may be provided for such purposes.

Accordingly, while the present invention has been disclosed in connection with exemplary embodiments thereof, it should be understood that other embodiments may fall within the spirit and scope of the invention, as defined by the following claims.

The invention claimed is:

1. An apparatus for chemical delivery to a scrubber, comprising:
a liquid delivery module comprising:
a first input adapted to receive a first input flow of a dilutant;
a second input adapted to receive a second input flow of a chemistry;
one or more flow couplers coupled to the first input and the second input, and adapted to combine the first input flow and the second input flow into a combined flow;
a mixing element coupled to the one or more flow couplers, and adapted to mix the combined flow such that a homogeneity of the combined flow is increased;
a flow splitter coupled to the mixing element and adapted to generate at least a first output flow and a second output flow from the combined flow;
a first output coupled to the flow splitter and adapted to direct the first output flow toward a first scrubber dispensing element; and
a second output coupled to the flow splitter and adapted to direct the second output flow toward a second scrubber dispensing element.

2. The apparatus of claim 1 wherein at least one flow coupler defines a turn in the first input flow adapted to redirect the first input flow so as to form flow disturbances that enhance blending of the first input flow and the second input flow.

3. The apparatus of claim 1 further comprising a check valve adapted to induce rotation of at least one of the first input flow and the second input flow.

4. The apparatus of claim 1 wherein the second input is adapted to receive an input flow of a first chemistry, and further comprising a third input adapted to receive an input flow of a second chemistry.

5. The apparatus of claim 4 further comprising a third output coupled to the flow splitter, and adapted to direct a third output flow toward a third scrubber dispensing element.

6. The apparatus of claim 1 further comprising a third output coupled to the flow splitter and adapted to direct a third output flow toward a third scrubber dispensing element; and.

7. The apparatus of claim 1 wherein the liquid delivery module is adapted to reduce wide input-output variations in a chemistry dilution factor.

8. The system of claim 1 wherein the mixing element is disposed within the one or more flow couplers.

9. A system for chemical delivery, comprising:
a scrubber having a first dispensing element and a second dispensing element each adapted to dispense a liquid on a substrate; and
a liquid delivery module comprising:
a first input adapted to receive a first input flow of a dilutant;
a second input adapted to receive a second input flow of a chemistry;
one or more flow couplers coupled to the first input and the second input, and adapted to combine the first input flow and the second input flow into a combined flow;
a mixing element coupled to the one or more flow couplers, and adapted to mix the combined flow such that a homogeneity of the combined flow is increased;
a flow splitter coupled to the mixing element and adapted to generate at least a first output flow and a second output flow from the combined flow;
a first output coupled to the flow splitter and adapted to direct the first output flow toward the first dispensing element; and
a second output coupled to the flow splitter and adapted to direct the second output flow toward the second dispensing element.

10. The system of claim 9 wherein at least one of the first and second liquid dispensing elements is adjacent a first substrate to be cleaned.

11. The system of claim 10 wherein:
the first liquid dispensing element is adjacent the first substrate; and
the second liquid dispensing element is adjacent a second substrate.

12. The apparatus of claim 9 wherein the one or more flow couplers, the mixing element and the flow splitter are located within a single manifold.

13. The system of claim 10 wherein:
the first liquid dispensing element is adjacent a first side of the first substrate and the second liquid dispensing element is adjacent a second, opposite side of the first substrate.

14. The system of claim 10 wherein:
the first liquid dispensing element is adjacent a first side of the first substrate and the second liquid dispensing element is adjacent the first side of the first substrate.

15. The system of claim 9 wherein the mixing element is adapted to mix the combined flow prior to entry in the flow splitter.

16. The system of claim 9 wherein the mixing element is disposed within the one or more flow couplers.

17. The system of claim 9 wherein the liquid delivery module is adapted to reduce a difference in a chemistry dilution factor between the first output flow and the second output flow to about 3% or less.

18. The system of claim 9 wherein the liquid delivery module is adapted to reduce a difference between a chemistry dilution factor of at least one of the first output flow and the second output flow and a chemistry dilution factor of the combined flow to about 3% or less.

19. The system of claim 9 wherein the combined flow has a chemistry dilution factor of about 150:1 to about 200:1.
